(19) United States
(12) Patent Application Publication
(10) Pub. No.: US 2014/0046015 A1
(43) Pub. Date: Feb. 13, 2014

(54) POLYCHLOROPRENE SOLID HAVING THIXOTROPIC PROPERTIES

(71) Applicants: Thomas-Oliver Neuner, Hilden (DE); Heiner Stange, Neuss (DE); Rolf Josten, Neuss (DE); Rolf Feller, Mettmann (DE); Mesut Fidan, Dormagen (DE)

(72) Inventors: Thomas-Oliver Neuner, Hilden (DE); Heiner Stange, Neuss (DE); Rolf Josten, Neuss (DE); Rolf Feller, Mettmann (DE); Mesut Fidan, Dormagen (DE)

(73) Assignee: LANXESS DEUTSCHLAND GMBH, Cologne (DE)

(21) Appl. No.: 14/112,600

(22) PCT Filed: Apr. 17, 2012
(86) PCT No.: PCT/EP12/56958

§ 371 Date: Oct. 18, 2013

(30) Foreign Application Priority Data
Apr. 21, 2011 (EP) 1163557.9

(51) Int. Cl. C08F 136/18; C08F 6/22

(52) U.S. Cl. CPC C08F 136/18; C08F 6/22
USPC 526/295

(57) ABSTRACT

The invention relates to a polychloroprene solid on the basis of a polychloroprene dispersion, said solid having thixotropic properties.

The invention relates to solid polychloroprene, to processes for obtaining and isolating it, and to the use thereof for production of rubber vulcanisates.

Polychloroprene production has been known for some time. By free-radical emulsion polymerization of chloroprene (2-chloro-1,3-butadiene), latices of polychloroprene are produced. Such latices are also referred to in the context of this application as “polychloroprene latices” or “polychloroprene dispersions”.

In the production, the monomers are admixed in an emulsifier system in an aqueous medium. This emulsifier system is generally anionic in nature; in rare cases, nonionic or cationic systems are also used. The temperature range in which the polymerization is performed encompasses values from approx. 0° C. to more than 80° C. Thus, the polymerization can be initiated by thermal free-radical initiators or by redox systems. In general, molecular weight regulators such as mercaptans or xanthogen disulphides are also used. In some cases, the molecular weight of the end product is also adjusted by copolymerization with sulphur and subsequent cleavage of the sulphidic bonds formed. The desired conversion is established by stopping the reaction with a suitable reagent.

Polychloroprene polymers are characterized by three essential criteria, namely the crystallization tendency, the polymer viscosity and, inter alia, the degree of prior crosslinking.

The prior art discloses polychloroprene polymers which have very low, low, moderately high and particularly high crystallization tendencies. Those with a particularly high crystallization tendency are used exclusively for application in the adhesives sector. The others with a lower crystallization tendency are employed in the manufacture of industrial rubber products, fabric rubberization, cables, hoses, moulded and injection-moulded articles, and foam rubber profiles.

For processing, the crystallization phenomena therefore play a very important role. Crystallization is understood to mean an increase in hardness as a function of storage time, the occurrence of which is enhanced particularly at low temperatures. The hardening is a reversible process and can be reversed as often as desired by heating or dynamic stress on the crystallized material.

The crystallization tendency can be adjusted through the choice of polymerization temperature during the polymerization. At polymerization temperatures of less than 20° C., polychloroprene polymers with high crystallization tendency are produced, which are particularly suitable for adhesives application. In the case of a polymerization temperature above 30° C., polychloroprene polymers which have a low crystallization tendency and are suitable for vulcanisates or rubber products are obtained.

In addition, the use of comonomers is also suitable for influencing the crystallization tendency of polychloroprene.

In the vast majority of cases, the dispersion of polychloroprene in water thus obtained is subsequently demonomerized by passing water vapour through. A portion of the product obtained finds direct industrial use as latex, but the majority is freed of adhering water by coagulation and sent to its final use as a solid product.

Solid polychloroprene (CR solid) and vulcanisates produced therefrom are notable, given appropriate blend formation, for high weathering and ozone stability, for flame retardancy, very good ageing properties, moderate oil stability, and for considerable resistance to many chemicals. They have good mechanical properties, good elastic characteristics and a high wear resistance.

Vulcanisates formed from polychloroprene latices (CR latices) have values very similar to those of natural latex vulcanisates with regard to elasticity, tensile strength, elongation at break and modulus, and at the same time also display good solvent, chemical, oil and fat stability.

As mentioned above, the removal of the polychloroprene solids from the dispersion is typically accomplished by coagulation. For this purpose, a number of different processes are known. By mixing the polychloroprene latices with a coagulant, the emulsion is broken. For this purpose, it is possible to use any standard coagulant. For example, the solids can be coagulated out of CR latices which have been produced under alkaline conditions by acidification, for example with a mineral acid or an organic acid. In many cases, mere acidification is insufficient for complete coagulation of the polychloroprene, and so strong electrolytes (salts containing polyvalent cations such as Mg²⁺, Ca²⁺ or Al³⁺) additionally have to be added to the acid.

A disadvantage in this method is the large amount of acid or electrolytes to achieve complete precipitation of the solids. At the same time, relatively large amounts of precipitant remain in the product, which can lead to a deterioration in important product properties. Therefore, the coagulated solid is washed with relatively large amounts of water to remove the precipitant, which leads to economic and ecological problems. The polychloroprene is in some cases obtained in the form of large lumps, which in their interior contain either still unprecipitated CR latex or excess precipitant.

It is also known from the prior art that the coagulation can be enabled by the action of higher temperatures and/or elevated pressures, and by additional action of electrolytes and shear forces. Such a product is subjected to considerable thermal stress, which leads to a deterioration in the product properties.

Typically, polychloroprene is removed from aqueous dispersions by freezing. This involves cooling below the freezing point of the aqueous phase to freeze the CR latex. In the course of subsequent thawing under suitable conditions, the polychloroprene is present as a coagulate and can be separated from the aqueous phase.

In order to arrive at coagulation rates sufficiently high for industrial purposes, the CR latex is frozen in thin layers. For this purpose, coagulation rollers coolable from the inside have been developed, which are immersed into the CR latex while rotating and take on a thin latex layer as they rotate, which freezes on the surface (U.S. Pat. No. 2,187,146). The thin film of CR coagulate and ice is removed from the roller with a scraper and passed on.

The prior art discloses further isolation processes. U.S. Pat. No. 4,103,074 describes a process for coagulating a polymer latex using a screw extruder, wherein the polymer latex is coagulated during conveying in the screw channel.

U.S. Pat. No. 3,926,877 describes a process for isolating a CR rubber, wherein the CR latex is mixed with an aqueous carbon black dispersion before being admixed with a coagulant. The coagulated product is separated from the aqueous phase.

DE 30 31 088 C2 discloses a process for producing a coagulated latex of a synthetic polymer, wherein a gaseous or liquid coagulant is applied to the polymer latex droplets in the form of a mist by means of a spray nozzle, and so polymer beads are precipitated.

Isolated polychloroprene solids are stored intermediately for use as CR vulcanisates. Even though they have excellent long-term ageing stability, they do not have unlimited stability and storability. During storage, over the course of time, a change occurs in the polymer properties, more particularly an increase in flowability, which leads to a considerable impairment of processability. This impairment of processability is manifested, more particularly, in poorer kneadability, spreadability and sprayability of the polychloroprenes, and in less favourable characteristics in machine processing.

To avoid these disadvantages, the solid polychloroprene is masticated to obtain low-viscosity polychloroprene types as solid rubbers. As is well known, the mastication of synthetic rubbers does not proceed as easily as that of natural rubber, especially when the rubbers have electron-withdrawing substituents such as Zn, Cl. The prior art discloses methods for thermooxidative CR degradation. These involve using, for example, dialkylxanthogen disulphides as molecular weight regulators.

Low-viscosity CR types produced in such a way have the disadvantage of having very high amounts of regulator. Also known is thermooxidative degradation by means of shear stress by the use of extruders, by lowering the molecular weight. This so-called mastication is very time-consuming and can cause high processing costs under some circumstances.

The prior art includes numerous attempts to influence the product properties of polychloroprene. For example, addition of sulphur-containing organic chain transfer agents, for example mercaptans, controls the molecular weight of the polymer formed. Also known is the preparation of high-viscosity chloroprene polymers by adding the chain transferer in portions during the polymerization. The number and magnitude of the regulator additions are, however, dependent on the polymerization temperature, the degree of conversion and the desired polymer viscosity. The additions of regulators additionally have to be made at particular monomer conversions.

It is an object of the invention to provide solid polychloroprene which has flow characteristics which bring advantages for processability, and a process for obtaining and isolating it.

This object is achieved by provision of solid polychloroprene based on polychloroprene dispersion having thixotropic properties.

Thixotropy is generally understood to mean a change in viscosity as a function of time at constant shear. These effects are generally caused by superstructures which change over the measurement time. One observation in the case of the present invention is the propensity of liquid substances to be converted temporarily to a state of lower viscosity at constant temperature by mechanical action/shearing (for example stirring, shaking or kneading). This propensity depends on the duration of the mechanical action.

Surprisingly, an inventive solution of solid polychloroprene pretreated by shearing has a decrease in structural order and, at the same time, an increase in structural order at rest. This property has the advantage that the CR solids have excellent miscibility, kneadability and processability with other additives.

Preferably, the change in viscosity occurs over the course of time. It is thus possible for the processing characteristics of various CR types to be adjusted to the requirements of the rubber processing industry.

The thixotropic property is preferably determined by means of the Brookfield viscosity method. To determine the thixotropic property, the inventive solid polychloroprene is brought into solution, preferably in organic solvents, for example in benzene, toluene, cyclohexane. Then the solution of solid polychloroprene is subjected to pretreatment by shearing by means of a propeller stirrer, and the viscosity is measured against time.

A further property of the inventive solid polychloroprene is the change in the melt viscosity after a pretreatment on a homogenization roller. The melt viscosity (Mooney 1+4 at 100° C., ASTM D 1646) preferably decreases as a function of the frequency of pretreatment on a homogenization roller. It has also been found that the melt viscosity degrades only slowly at about 20 cycles on the homogenization roller, which is attributable to the reduction in chain length.

A homogenization roller is understood to mean a roller which is not suitable for mastication of a rubber. The homogenization roller differs from a mastication roller in the lower specific energy input thereof. A high energy input as is the case for the mastication roller causes destruction of the polymer chain and hence lowering of the melt viscosity.

It has been found that the inventive solid polychloroprene is preferably obtained from a polychloroprene dispersion which has been produced by means of an emulsion polymerization at a polymerization temperature greater than 30° C., preferably between 35° C. and 50° C.

The invention further relates to a process for isolating and obtaining polychloroprene solids, wherein an aqueous polychloroprene dispersion is contacted with water vapour comprising coagulant, such that the inventive solid polychloroprene coagulates.

It has been found that, surprisingly, the product property of the solid polychloroprene has been influenced and altered by the process according to the invention, even though the polychloroprene dispersion has been produced by conventional processes.

It preferably coagulates in strand form or in the form of crumbs.

The precipitated solid polychloroprene is subsequently separated from the coagulation suspension and then preferably dewatered in a dewatering apparatus. For example, it is possible here to use a Seiher screw or dewatering rollers. Other known dewatering apparatus is likewise conceivable.

Subsequently, the dewatered solid polychloroprene is dried by means of a drying apparatus. The drying apparatus is, for example, a twin-shaft extruder, a drying screw or a drying kneader. It is possible with preference to add additives and/or inerts in the drying apparatus. It is thus possible to optimally influence the product properties of the inventive solid polychloroprene for any requirement. Additives for influencing the product properties are preferably, for example, stabilizers, accelerators, emulsifiers, alkalis, ageing stabilizers, viscosity-influencing processing aids. It is possible to use all conventional additives. Inerts are, for example, nitrogen, argon, carbon dioxide, which are added to influence the polymer melting temperatures.

The inventive solid polychloroprene is preferably pelletized by means of underwater pelletization and cooled.

The polychloroprene dispersion is preferably a latex which has been produced by means of emulsion polymerization. The polymerization is effected at polymerization temperature greater than 30° C., preferably between 35° C. and 50° C., more preferably between 35° C. and 45° C., the polymerization conversion being between 50% and 80%. Excess monomer is removed by means of vacuum devolatilization to a range from 1000 ppm to 1 ppm. Emulsion polymerization processes are known from the prior art and can be used here.

For the polymerization, it is also possible with preference to add various comonomers, for instance 2,3-dichlorobutadiene, to chloroprene (2-chloro-1,3-butadiene) to control the crystallization.

The polychloroprene dispersion preferably has a solids content between 20-45% by weight and a gel content between 0-10% by weight. However, the gel content can also be increased in a controlled manner.

The water vapour comprising coagulant is formed by means of water vapour and an aqueous coagulant solution. The coagulant solution used is preferably an aqueous solution of a coagulant composed of inorganic salts, preferably of metals of the second and third main groups of the Periodic Table.

The coagulant used is preferably calcium chloride, magnesium chloride, magnesium sulphate, aluminium chloride and/or aluminium sulphate.

Preferably, the coagulant solution has a coagulant concentration between 1% by weight and 60% by weight, preferably between 2% by weight and 55% by weight, more preferably between 10% by weight and 35% by weight, based on the coagulant solution.

Preference is given to diluting the polychloroprene dispersion prior to contact with the water vapour comprising coagulant.

In this case, the polychloroprene dispersion is preferably diluted to a solids content of 38% by weight to 45% by weight, preferably of 28% by weight to 35% by weight and more preferably of 20% by weight to 28% by weight, based on the polychloroprene dispersion.

For the dilution, preference is given to using water, more preferably demineralised water.

The dilution is important in that not only is the conglutination and blocking of the flow/coagulation apparatus prevented or reduced, but in that it is also possible to ensure optical coagulation, caused by the contact between the CR dispersion and the water vapour comprising coagulant.

Particular preference is given to using 80 to 1000 kg of water vapour per tonne of solids of the polychloroprene dispersion, preferably 80 to 300 kg of water vapour per tonne of solids of the polychloroprene dispersion.

In addition, 10 to 40 kg of coagulant are used per tonne of solids of the polychloroprene dispersion, preferably 10 to 25 kg of coagulant per tonne of solids of the polychloroprene dispersion.

For the coagulation, the aqueous polychloroprene dispersion is added in a flow/coagulation apparatus, said flow/coagulation apparatus having recesses through which the water vapour comprising coagulant can pass and encounters the polychloroprene dispersion in the flow/coagulation apparatus. This coagulates the inventive solid polychloroprene.

The solid polychloroprene is preferably dewatered in the dewatering apparatus down to a residual moisture content of 10% by weight to 15% by weight, preferably 1.0% by weight to 9% by weight, based on the solid polychloroprene.

In the drying apparatus, the dewatered solid polychloroprene is preferably dried down to a residual moisture content of 1% by weight to 1.5% by weight, preferably 0.5% by weight to 1% by weight, more preferably 0.1% by weight to 0.5% by weight, based on the dewatered solid polychloroprene.

At the end of the drying phase in the drying apparatus, the solid polychloroprene is present as a rubber melt. The melt passes through a head plate and is processed with a cutting apparatus and cooled and transported in the underwater pelletization by water.

Preference is given to adding a separating agent to the water in the underwater pelletization. Examples of useful separating agents here include talc, metal stearates. Other conventional separating agents are likewise conceivable.

A further invention is the use of the inventive solid polychloroprene for production of vulcanisates. The invention likewise provides the vulcanisates comprising the inventive solid polychloroprene.

The invention is illustrated in detail hereinafter by examples and a drawing:

### EXAMPLES

Production of a Polychloroprene Dispersion

A polychloroprene dispersion is produced using the base formulation below (figures are in parts by weight per 100 parts by weight of chloroprene used):
125 parts by wt. of water
100 parts by wt. of monomers
   (2-chloro-1,3-butadiene or a mixture of 2-chloro-1,3-butadiene and 2,3-dichlorobutadiene)
3 parts by wt. of sodium salt of disproportionated abietic acid
0.5 part by wt. of potassium hydroxide
0.2 part by wt. of n-dodecyl mercaptan
0.5 part by wt. of sodium salt of formaldehyde-condensed naphthalenesulphonic acid

The polychloroprene dispersion is produced by free-radical emulsion polymerization between 40° C. and 45° C. from the above components by customary methods (e.g. Ullmanns Encyclopaedia of Industrial Chemistry, Vol 23A, p. 252-262). The polymerization is stopped at a conversion between 50% and 70% and the dispersion is freed of residual monomers by vacuum devolatilization.

Process for Isolation and Recovery of an Inventive Solid Polychloroprene

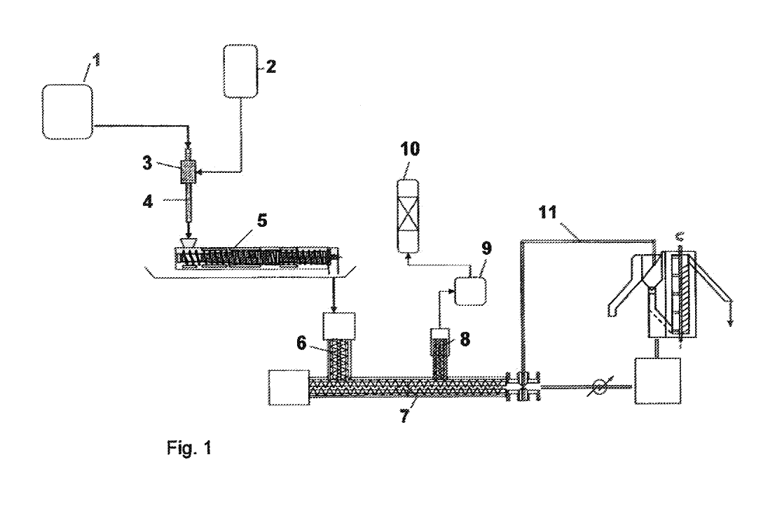

FIG. 1 shows a schematic structure of a process according to the invention.

The abovementioned polychloroprene dispersion is conveyed from a tank 1 into a flow/coagulation apparatus 3. Prior to introduction into the flow/coagulation apparatus 3, the polychloroprene dispersion can be diluted with water.

From a further tank 2, the aqueous coagulant, which has been mixed with water vapour beforehand, is supplied to the flow/coagulation apparatus 3 and contacted with the polychloroprene dispersion via the recesses therein. In the course of this, the polychloroprene dispersion is quantitatively precipitated in the flow/coagulation apparatus 3 and in the downstream precipitation tube 4.

The precipitation tube 4 opens into the intake region of the dewatering apparatus 5, wherein the inventive precipitated solid polychloroprene is dewatered.

The dewatered solid polychloroprene is supplied to the drying apparatus 7 either as a strand or in the form of crumbs and dried. In order to influence the product properties of the inventive solid polychloroprene, additives or inerts can he metered in in the feed screw 6 or in the downstream region of the drying apparatus 7.

Via domes 8 under reduced pressure, the vapours are drawn off and the retention of rubber particles is ensured with stuffing screws in the domes 8. Beyond the domes 8 are separators 9 in which entrained rubber particles are separated out and subsequently supplied to a waste air scrubber 10.

The hot rubber melt from the drying apparatus 7 is cut into chips in the underwater pelletization via a head plate and cutting blades. The chips are cooled and transported by means of a water stream 11 which may optionally be admixed with additives (e.g. separating agents).

The chips are first separated from the water by means of a sieving chute. The residual energy of the chips evaporates the water adhering on the surface. In addition, a warm air stream can promote the removal of the adhering water.

The inventive solid polychloroprene thus obtained is used for the further property determinations.

Thixotropic Property by Means of the Brookfield Viscosity Method

For the determination of the thixotropic property, the inventive solid polychloroprene and a comparative example are dissolved in toluene.

The comparative example used is a solid polychloroprene which has been obtained from the abovementioned polychloroprene dispersion by means of a conventional freeze coagulation with subsequent drying in a nozzle belt dryer.

8.6 g of solid polychloroprene in each case were weighed with 91.4 g of toluene into an Erlenmeyer flask and stirred at room temperature by means of a magnetic stirrer bar until complete solubility of the solid polychloroprene.

For introduction of shear, both toluenic polychloroprene solutions are pretreated by rapid stirring with a propeller stirrer at 500 rpm for about 1 minute.

The viscosity is measured by means of a rotary viscometer of the Brookfield DV-II+ brand at 60 rpm, spindle 2 at 25° C.

TABLE 1
Viscosity profile after shear

| Measurement time/min | Viscosity/mPas |
|---|---|
| 00:00 | 170 |
| 00:01 | 178 |
| 00:02 | 182 |
| 00:07 | 186 |
| 00:22 | 188 |

The viscosity profile indicated in Table 1 is found after the above-described pretreatment with subsequent viscosity measurement.

TABLE 2
Viscosity profile after storage

| Measurement time/min | Viscosity/mPas |
|---|---|
| 00:00 | 230 |
| 00:01 | 202 |
| 00:02 | 198 |
| 00:05 | 193 |
| 00:10 | 191 |

The viscosity profile indicated in Table 2 is found after storage of the polymer solution described in Table 1 at 25° C. without shear for 30 minutes.

The polymer solution produced with the inventive solid polychloroprene has thixotropic behaviour. The viscosity thereof is shear time-dependent and approaches an equilibrium in an asymptotic manner at constant shear. From the state of rest, the viscosity in a measurement accordingly falls down to an equilibrium. If additional shear energy is introduced into this solution by means of the abovementioned propeller stirrer and the viscosity is measured immediately, opposite behaviour is observed; the viscosity rises towards the same equilibrium viscosity.

A polymer solution produced with the comparative example does not exhibit this behaviour. The polymer solution has structurally viscous but not thixotropic behaviour. The measurement after storage and pretreatment always gives a constant value of 104 mPas for the same measurement time.

Melt Viscosity Profile after Pretreatment on a Homogenization Roller

For the determination, the abovementioned inventive example and the abovementioned comparative example were compared. Shear was introduced at 25° C. in a laboratory roller, which has a roller width of 30 cm and a roller gap of I mm and a rotation of 10 rpm/10 rpm (front/back roller).

About 200 g of solid polychloroprene was used in each case. A Mooney viscosity was measured to ASTM D 1646 (Mooney 1+4 at 100° C.).

TABLE 3
Melt viscosity profile

| | | Comparative |
|---|---|---|
| | Inventive example | example |
| Type/pretreatment | ML1 + 4/ME | ML1 + 4/ME |
| Inventive solid polychloroprene | 56 | 51 |
| 0 value | | |
| Inventive solid polychloroprene | 48 | 50 |
| 10 cycles in roller | | |
| Inventive solid polychloroprene | 46 | 51 |
| 20 cycles in roller | | |

It has been found that, surprisingly, the inventive CR solid exhibits a superstructure, i.e. the melt viscosity (Mooney 1+4 at 100° C.) depends on the pretreament of the polymer. While the comparative example, in spite of a pretreatment, has a constant viscosity, the viscosity declines for the inventive solid polychloroprene. The decrease is asymptotic towards an equilibrium value.

Ageing Properties of Vulcanisates

It has been found that there is a change in the ageing properties of the vulcanisates which have been produced with the inventive solid polychloroprene, and that the hardening thereof is reduced in the course of storage under standard atmosphere at 100° C. for 7 days.

For the measurement of the properties, the following blend formulation was used:

TABLE 4
Blend formulation for production of the vulcanisates

| Batch name: | parts/phr |
|---|---|
| Polymer | 100 |
| Carbon black N772 | 30 |
| Stearic acid | 0.5 |
| MgO | 4 |
| ETU | 0.4 |
| ZnO | 5 |

The polymers used are the inventive solid polychloroprene and the comparative example as described above.

The carbon black used was a Cabot carbon black Regal SRF N772.

As a sulphur donor, ethylenethiourea from Rheinchemie “Rhenogran ETU-80”.

“phr” means parts per hundred of rubber.

The blend was produced in a “Standard Internal Mixer” to ASTM D3182. The vulcanization was performed at 160° C. for a period of 30 minutes. The specimens were produced to ASTM D 3182. Tensile strain tests were conducted before and after heat ageing at 100° C. for 7 days (DIN 53508) on an S2 tensile specimen (to DIN 53504) at room temperature.

The hardness was measured to DIN 53505 as the Shore A hardness at room temperature.

TABLE 5
Initial values of stress-strain and hardness

| Type and ageing | | | |
|---|---|---|---|
| temp. for 7 d | | Comparative example | Inventive example |
| Stress S10 | MPa | 0.5 | 0.5 |
| Stress S25 | MPa | 0.9 | 1 |
| Stress S 50 | MPa | 1.4 | 1.6 |
| Stress S 100 | MPa | 2.4 | 2.7 |
| Stress S 300 | MPa | 15.0 | 16.8 |
| Elongation at break | % | 370 | 377 |
| Tensile strength | MPa | 20 | 23 |
| Hardness | Sh A | 59 | 61 |

As evident from Table 5, the vulcanisates produced from the conventionally produced solid polychloroprene (comparative example) and from the inventive solid polychloroprene exhibit virtually the same vulcanisate properties in terms of tensile strain. They also exhibit similar Shore hardness.

TABLE 6
Vulcanization properties after ageing at 100° C.
under standard atmosphere for 7 days

| Type and ageing temp. | | Comparative | Inventive |
|---|---|---|---|
| for 7 d | | example 100° C. | example 100° C. |
| Change in S10 | % | 80 | 60 |
| Change in S25 | % | 100 | 50 |
| Change in S 50 | % | 121 | 67 |
| Change in S 100 | % | 154 | 77 |
| Change in S 300 | % | | |
| Change in elongation at | % | −48 | −37 |
| break | | | |
| Change in tensile | % | −27 | −29 |
| strength | | | |
| Change in ShA hardness | Sh A | 12 | 9 |

Table 6 describes the tensile strain properties of an S2 tensile specimen of the comparative example which has been stored under standard atmosphere at 100° C. for 7 days. Various ageing processes result in hardening of the vulcanisate test specimen of the comparative example, illustrated by the rise in the stress values for a given strain and by the rise in the Shore hardness.

A lower degree of hardening is clearly evident in the vulcanisate test specimen produced with the inventive solid polychloroprene. This leads either to a higher sustained operation temperature of the vulcanisate or, at the same temperature, to an increased service life and hence to a distinct improvement in the vulcanisate.

What is claimed is:

1. Solid polychloroprene based on a polychloroprene dispersion, characterized in that it has thixotropic properties.

2. Solid polychloroprene according to claim 1, characterized in that a solution of solid polychloroprene pretreated by shearing has a decrease in structural order and, at rest, an increase in structural order of the same solution of solid polychloroprene.

3. Solid polychloroprene according to claim 2, characterized in that the thixotropic property (change in viscosity) occurs over the course of time.

4. Solid polychloroprene according to claim 3, characterized in that the thixotropic property is determined by means of the Brookfield viscosity method.

5. Solid polychloroprene according to claim 4, characterized in that it is obtained from a polychloroprene dispersion which has been produced by means of an emulsion polymerization at a polymerization temperature greater than 30° C., preferably between 35° C. and 50° C.

6. Solid polychloroprene according to claim 5, characterized in that the pretreatment decreases the melt viscosity (Mooney 1+4 at 100° C., ASTM D 1646).

7. Solid polychloroprene according to claim 6, characterized in that the pretreatment for the melt viscosity is performed by means of a roller.

8. Process for isolating and obtaining solid polychloroprene according to any of the preceding claims, characterized in that an aqueous polychloroprene dispersion is contacted with water vapour comprising coagulant, which coagulates the solid polychloroprene.

9. Process according to claim 8, characterized in that the solid polychloroprene is separated from the coagulation suspension.

10. Process according to claim 9, characterized in that the solid polychloroprene is dewatered by means of a dewatering apparatus.

11. Process according to claim 10, characterized in that the dewatered solid polychloroprene is dried by means of a drying apparatus.

12. Process according to claim 11, characterized in that additives and/or inerts are added to the dewatered solid polychloroprene in the drying apparatus.

13. Process according to claim 12, characterized in that the dried dewatered solid polychloroprene is pelletized by means of underwater pelletization and cooled.

14. Process according to claim 13, characterized in that the polychloroprene dispersion is a latex.

15. Process according to claim 14, characterized in that the polychloroprene dispersion is produced by means of emulsion polymerization, the polymerization temperature being greater than 30° C., preferably between 35-50° C.

16. Process according to claim 15, characterized in that the water vapour comprising coagulant is formed by means of water vapour and an aqueous coagulant solution.

17. Process according to claim 16, characterized in that the coagulant solution used is an aqueous solution of inorganic salts (coagulant), preferably of metals of the second and third main groups of the Periodic Table.

18. Process according to claim 17, characterized in that the coagulant used is calcium chloride, magnesium chloride, magnesium sulphate, aluminium chloride and/or aluminium sulphate.

19. Process according to claim 18, characterized in that the coagulant solution has a coagulant concentration between 1% by weight and 60% by weight, preferably between 2% by weight and 45% by weight, more preferably between 10% by weight and 35% by weight, based on the coagulant solution.

20. Process according to claim 19, characterized in that the polychloroprene dispersion is diluted prior to contact with the water vapour comprising coagulant.

21. Process according to claim 20, characterized in that the polychloroprene dispersion is diluted to a solids content of 38% by weight to 45% by weight, preferably of 28% by weight—35% by weight and more preferably of 20% by weight—28% by weight, based on the polychloroprene dispersion.

22. Process according to claim 16, characterized in that 80 kg to 1000 kg of water vapour/t of solids of the polychloroprene dispersion, preferably 80 kg-250 kg of water vapour/t of solids of the polychloroprene dispersion, are used.

23. Process according to claim 18, characterized in that 10 to 40 kg of coagulant/t of solids of the polychloroprene dispersion, preferably 10 kg-25 kg of coagulant/t of solids of the polychloroprene dispersion, are used.

24. Process according to claim 23, characterized in that the aqueous polychloroprene dispersion flows through a flow/coagulation apparatus, said flow/coagulation apparatus having recesses through which the water vapour comprising coagulant can pass and encounters the polychloroprene dispersion in the flow/coagulation apparatus.

25. Process according to claim 10, characterized in that the solid polychloroprene is dewatered in the dewatering apparatus down to a residual moisture content of 10% by weight to 15% by weight, preferably 1.0% by weight to 9% by weight, based on the solid polychloroprene.

26. Process according to claim 11, characterized in that the dewatered solid polychloroprene is dried in the drying apparatus down to a residual moisture content of 1% by weight to 1.5% by weight, preferably 0.5% by weight to 1% by weight, more preferably 0.1% by weight to 0.5% by weight, based on the dewatered solid polychloroprene.

27. Process according to claim 26, characterized in that the dried solid polychloroprene is present as a rubber melt at the end of the drying phase in the drying apparatus,

28. Process according to claim 27, characterized in that separating agents are added to the water in the underwater pelletization.

29. Use of the solid polychloroprene according to any of the preceding claims for production of vulcanisates.

30. Vulcanisates according to claim 29.
